(19) United States
(12) Patent Application Publication
(10) Pub. No.: US 2006/0055531 A1
(43) Pub. Date: Mar. 16, 2006

(54) Combined RF tag and SAW sensor

(75) Inventors: James D. Cook, Freeport, IL (US); Richard L. Dale, Freeport, IL (US)

Correspondence Address: Kris T. Fredrick;Honeywell International, Inc., 101 Columbia Rd., P.O. Box 2245, Morristown, NJ, 07962, US

(73) Assignee: Honeywell International, Inc.

(21) Appl. No.: 10/940,239

(22) Filed: Sep. 14, 2004

(51) Int. Cl. G08B 1/08

(52) U.S. Cl. 340/539.22; 340/572.1

(57) ABSTRACT

Sensors and transponders combined on a single semiconductor substrate package. The invention includes an RFID tag and a sensor commonly assembled onto a common substrate. The substrates can be provided in the form of a flex circuit or printed circuit board. The flex circuit would be fabricated using standard flex circuit fabrication methods. It is a polymer/metal laminate film structure and incorporates the antenna pattern for the sensor and RFID tag system on the circuit. The flex circuit can also combine antennas for the sensor and the RFID tag onto a single flex circuit substrate, thus eliminating the need for separate antennas.

### FIELD OF THE INVENTION

The present invention is generally related to sensors such as surface acoustic wave. The present invention is also related to communication of data using transponders such as radio frequency identification (RFID) tags. More particularly, the present invention is related to the combination of sensors and transponders on a single semiconductor substrate package.

### BACKGROUND

Sensors, such as Surface Acoustic Wave (SAW) sensors, are used for many industrial and environmental applications. SAW sensors can be used to sense pressure, temperature, torque, and humidity from various media such as liquid, vapor and gas.

Transponders, such as RFID tags, provide a data communications solution for various applications such as inventory tracking and asset management, yet none combine a sensor with a tag.

There is a growing need for remote and distributed system monitoring using sensors. Data collected from sensors must be stored and/or communicated to a monitoring system. As sensing applications are developed, there will be a need for smaller form-factors or profiles for sensors and means to communicate their collected data.

### SUMMARY OF THE INVENTION

The present inventors realized that space limitations and new uses for sensing technologies is creating a need for a reduction in components sizes without sacrificing accuracy in data collection or reporting. Therefore, the present invention is provided to address the need in the art for compact, yet accurate sensing systems.

It is a feature of the present invention to combine radio frequency identification (RFID) transponders and sensor onto a single substrate or package.

It is another feature of the present invention to use a combined surface acoustic wave (SAW) and a RFID tag in a pressure vessel application.

It is another features of the present invention to use flex circuit design adapted to support a combined sensor and a RFID chip tag system.

It is another features of the present invention to use flex circuit antenna design assembled with a combined sensor and a RFID chip tag.

In accordance with an embodiment of the present invention, the RFID tag can be provided as a SOIC package and the sensor are combined onto a common substrate, which can be provided in the form of a flex circuit or printed circuit board. The flex circuit would be fabricated using standard flex circuit fabrication methods. It is a polymer/metal laminate film structure and incorporates the antenna pattern for the sensor and RFID tag system on the circuit. The flex circuit can also combine antennas for the SAW sensor and the RFID tag onto a single flex circuit substrate, thus eliminating the need for separate antennas.

The invention described herein can be used as a component in pressure vessel applications (e.g., such as tires, hoses, pipes, oil storage tanks, weapon crates, etc.). Other devices, systems and applications within which the invention can be utilized are: biological agent detection, detection of combustible gases, chemical warfare agent detection, weapon state of health, shipping container monitoring, packaged goods monitoring, tamper detection systems, pressure vessel monitoring, processed food containers, drug packaging security monitors, and remote environment monitoring devices and system.

### BRIEF DESCRIPTION OF THE DRAWINGS

FIG. 1 is a top view of a combined RFID tag and sensor, wherein the RFID tag and sensor are mounted next to each other on a substrate.

FIG. 2 is a side view of the combined RFID tag and sensor of FIG. 1.

### DETAILED DESCRIPTION OF THE INVENTION

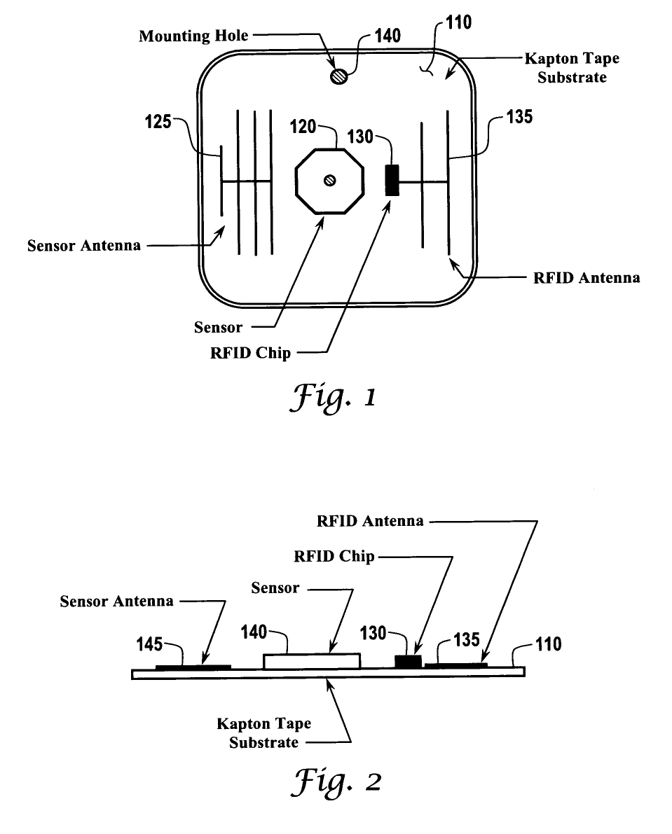

Referring to FIGS. 1 and 2, illustrated are respective top and side views of a combined sensor 120 and RFID transponder (RFID tag) 130, which can be refereed to when provided in combination as a “tagsensor” 100. The tagsensor 100 includes a substrate 110 whereon the RFID tag 130 and sensor 120 are mounted next to each other. The RFID tag includes a RFID antenna 135, and the sensor can include it own sensor antenna 125. As shown in FIG. 1, the tagsensor 100 can include a mounting hole 140, through which the tagsensor can be secured to a system, article or in an environment that is to be monitored by the sensor 120. Other means in the art can be used to easily attach the tagsensor 100 to most surfaces; for example adhesive can be used to mount the tagsensor 100.

It is preferred during application of the tagsensor 100 within a monitored situation that the tagsensor be self-powered. Although batter back-up (not shown) can be utilized with the tagsensor, most applications will require that the tagsensor be deployed in remote or inaccessible environments. Therefore, power to the tagsensor should be provided via radio frequency (RF) signaling, given RF tag powering methods known in the art.

During use, it is anticipated that the tagsensor will be used in portable wireless interrogation architecture, wherein the tagsensor is interrogated periodically by an external RF source.

It is preferred that the tagsensor be adapted for use in a multiple parameter sensing applications. For example, the tagsensor may be used for pressure, temperature, gas, chemical or humidity sensing applications. Depending on the application that the tagsensor is being used for, the sensor 120 can be provided with pressure, temperature, chemical, optical, liquid, or vapor sensing abilities. It should be appreciated that a multi-sensor tagsensor 100 can be provided, so long as the space and power requirements accounted for in the tagsensor's design. A specific application described in further detail below requires use of a SAW sensor for measuring pressure.

The RFID tag 130 is preferably adapted as an information storing tag. Tags are available that can read/write 2048 bits, provide for sensor self identification, and store multiple sensor events.

RFID tags and sensor can also be adapted to perform self-tests, which may be necessary during long deployments/operation of the tagsensor 100. An internal reference sensor or coding can be provided to provide the tagsensor with self test capabilities.

The tagsensor 100 will preferably be provided in a small form factor. A tagsensor up to 2 inches long/tall is desirable. The tagsensor's width typically should be less than about one-tenth of the overall length/height of the tagsensor 100. It is also desirable that the tagsensor be lightweight. For example, a tagsensor with an overall height/length of 2 inches can be expected to weight about 12 grams. The foregoing considerations should result in a low cost production tagsensor.

The RFID tag and sensor can operate using standard ISM Bands. The RFID tag Frequency generally will be 915 MHz. The typical SAW Frequency is about 434 MHz. Flex circuit antennas can be assembled with a combined sensor and a RFID chip tag to enhance communications ability of the invention.

The substrate 110 used to mount the sensor 120 and RFID tag 130 can be provided, for example, as a Kapton Tape substrate. The substrate should be electrically insulating and provide adequate space for the RFID tag 130 and sensor 120 components. There should also be enough room on the substrates surface or thickness for RFID and sensor antennas. The Antennas may be secured to the surface of the substrate similar to solder runs on a circuit board, or the antenna can be embedded within the substrate similar to a multilayered circuit board containing solder runs embedded between surface layer and bottom layers. Therefore, a common substrate for the RFID tag 130 and SAW sensor 120 can be provided in the form of a flex circuit or printed circuit board. The flex circuit would be fabricated using standard flex circuit fabrication methods. It is a polymer/metal laminate film structure and incorporates the antenna pattern for the sensor and RFID tag system on the circuit. The flex circuit can also combine antennas for the SAW sensor and the RFID tag onto a single flex circuit substrate, thus eliminating the need for separate antennas.

It is anticipated that a specific application by the assignee of the present invention will be for use the tagsensor described herein in a pressure vessel applications (e.g., ascertaining component pressure in objects such as tires, hoses, pipes, oil storage tanks, weapon crates, etc.). The invention can also be used as a other devices, systems and applications within which the invention can be utilized are: biological agent detection, detection of combustible gases, chemical warfare agent detection, weapon state of health, shipping container monitoring, packaged goods monitoring, tamper detection systems, pressure vessel monitoring, processed food containers, drug packaging security monitors, and remote environment monitoring devices and system.

1. A monitoring and reporting system, comprising:
a substrate;
a radio frequency identification (RFID) transponder mounted on the substrate; and
a sensor mounted on the substrate with the RFID transponder.

2. The invention of claim 1 wherein the monitoring and reporting system is adapted for use in a pressure vessel application.

3. The system of claim 1 wherein said substrate comprises a flex circuit adapted to support the sensor and the RFID transponder provided as a chip tag system.

4. The system of claim 3 including a flex circuit antenna on the flex circuit.

5. The system of claim 1 wherein said substrate comprises a printed circuit board adapted to support the sensor and the RFID transponder.

6. The system of claim 5 including at least one antenna on the printed circuit board for at least one of the RFID transponder and the sensor.

7. The invention of claim 1 wherein the monitoring and reporting system is adapted for use in at least one of: vessel pressure determination, temperature determination, light determination, chemical identification, biological agent identification, security breach detection, environmental measurements, water measurement, and vapor measurement.

8. A monitoring and reporting system, comprising:
a substrate:
a radio frequency identification (RFID) transponder mounted on the substrate; and
a surface acoustic wave (SAW) sensor mounted on the substrate with the RFID transponder.

9. The invention of claim 8 wherein the monitoring and reporting system is adapted for use to determine the pressure inside a vessel.

10. The system of claim 8 wherein said substrate comprises a flex circuit adapted to support the SAW sensor and the RFID transponder chip tag system.

11. The system of claim 10 including a flex circuit antenna on the flex circuit.

12. The system of claim 8 wherein said substrate comprises a printed circuit board adapted to support the SAW sensor and the RFID transponder chip tag system.

13. The system of claim 12 including an antenna on the printed circuit board.

14. The invention of claim 1 wherein the monitoring and reporting system is adapted for use in at least one of: vessel pressure determination, temperature determination, light determination, chemical identification, biological agent identification, security breach detection, environmental measurements, water measurement, and vapor measurement.

15. A tagsensor, comprising:
a substrate provided in the form of a flex circuit:
a radio frequency identification (RFID) transponder and associated RFID transponder antenna mounted on the substrate; and
a sensor and associated sensor antenna mounted on the substrate with the RFID transponder.

16. The invention of claim 15 wherein the monitoring and reporting system is adapted for use in at least one of: vessel pressure determination, temperature determination, light determination, chemical identification, biological agent identification, security breach detection, environmental measurements, water measurement, and vapor measurement.

17. The system of claim 15 wherein said substrate comprises a flex circuit adapted to support the sensor and the RFID transponder provided as a chip tag system.

18. The system of claim 17 including a mounting hole formed through the substrate.

19. The system of claim 15 wherein said substrate comprises a printed circuit board adapted to support the sensor and the RFID transponder.

20. The system of claim 19 including at least one antenna on the printed circuit board for at least one of the RFID transponder and the sensor.
